(19) United States
(12) Patent Application Publication
(10) Pub. No.: US 2005/0116042 A1
(43) Pub. Date: Jun. 2, 2005

(54) Magnetic retaining or holstering device for attaching a hand-held scanner to the body

(76) Inventor: Matthew F. Willkens, Seattle, WA (US)

Correspondence Address: ORUM & ROTH, 53 W. JACKSON BLVD, CHICAGO, IL, 60604, US

(21) Appl. No.: 10/921,255

(22) Filed: Aug. 18, 2004

Related U.S. Application Data
(60) Provisional application No. 60/496,223, filed on Aug. 18, 2003.

(51) Int. Cl. G06K 7/10

(52) U.S. Cl. 235/462.44; 235/472.01

(57) ABSTRACT

A retaining device for keeping wireless device such as a portable data entry device close at hand. One end of the portable data entry device has a detachable cap magnetically affixed to one end. The detachable cap has a clip or other connector for securing the portable data entry device to the user. The retaining device allows easy access to the wireless device and allows the device to be secured out of the way when not in use.

This application claims the benefit of U.S. Provisional Application No. 60/496223 filed Aug. 18, 2003.

### BACKGROUND OF THE INVENTION

1. Field of the Invention

The present invention is directed to a connector device for portable data Collection devices, particularly for scanners or integrated terminals, of the type composed of two elements releasable connected to one another. A first of those elements includes a first magnetic surface and said element is connected to a clip, and a second of these elements includes a second magnetic surface that is connectible to a portable data collection device, whereby the first and second magnetic surfaces are of at least partially insertable forms to prevent the sliding of the two elements relatively each other.

2. Description of Related Art

Holsters have been typically used in the past to hold portable data entry devices such as scanners. A disadvantage of holsters is that they require substantial time and efforts to get data collection devices in and out. Meanwhile, logistics companies demand for their applications small wireless devices that are simple to manipulate independently or in connection with operations on a conveyor belt, and they want a way to tether it quickly so that users can move objects, for example, boxes, when they are not scanning.

Another prior art device tethers the data entry device to the user by use of a retractable cord. The cord may limit the user's ability to get the scanner close enough to scan with inconveniently or awkwardly placed objects. Further, it limits the user's ability to share the scanner with a second user.

The use of different magnetic connectors for electrical devices is described in several patents. For example, U.S. Pat. No. 6,590,395 “Connector device for a sensor of actuator” describes a connector device for a sensor or actuator that is composed of two terminal elements releasably connected to one another. U.S. Pat. No. 6,561,815 “Electromechanical connecting device” describes an electromechanical connector having a pair of detachably mateable contact mechanisms the housing of at least one of which includes an elastic wall to which is coupled to a magnetic member. U.S. Pat. No. 6,283,594 “Grip devices for eyeglasses” describes a grip device to prevent eyeglasses having a bridge piece from slipping downwardly on the nose over time. The device comprises two mutually removable attachment components, where connector material is magnetic. U.S. Pat. No. 6,499,437 “Magnetic connector” describes a magnetic connector that includes first and second connector parts, each having a respective magnet. The first and second magnets are oriented to automatically hold the first and second connector parts together, with the first connector part disposed in a first position between the overhanging lip and the cord loop. U.S. Pat. No. 6,591,462 “Magnetic jewelry clasp with safety catch” describes a jewelry clasp that comprises of two bodies, each having a surface magnetically attracted to the other. The clasp has a safety catch that includes an arm hinged to one of the bodies. A magnetic attraction keeps the arm in the closed position until opened. If desired, a male connector may be inserted into a female connector are usable in tandem with the retaining wall, or in lieu thereof. U.S. Pat. No. 5,916,340 “Magnetic socket wrench connector tip” describes a magnetic socket wrench connector tip that comprises a male connector tip for inserting into the female end of a socket. A magnet is partially embedded in the front face of the tip. A magnet is slidably positioned within the tube, and partially projecting from its front end. A spring is positioned within the tube and behind the magnet for absorbing shock when a fastener is pushed against the magnet. The magnetic socket wrench connector tip may be provided on any socket wrench tool with a connector tip, including ratcheting handles and extension bars.

There is a need for a device to connect a wireless device to a user that allows quick and easy access to the device, the ability to quickly and easily reattach the device to the user, the ability to use the wireless device in all locations and to share it with another user if necessary.

### SUMMARY OF INVENTION

The present invention provides a device comprising of a snap cap integrated with a magnet that is operationally connected with a clip by a flexible connector, and a receptacle including magnet that is shaped to accommodate the snap cap. The receptacle is connected with an integrated terminal or scanning device, wireless data entry device or other wireless device. The retaining device allows easy access to the wireless device and allows the device to be secured out of the way when not in use.

### BRIEF DESCRIPTION OF THE DRAWINGS

FIG. 1 is a magnetic retaining device when a snap cap and a retainer are not connected.

FIG. 2 is a magnetic retaining device when a snap cap and a retainer are connected together.

FIGS. 3a-3c are alternative embodiments of the invention.

FIG. 4 is a scanner attached to the operator by a magnetic retaining device.

### DETAILED DESCRIPTION

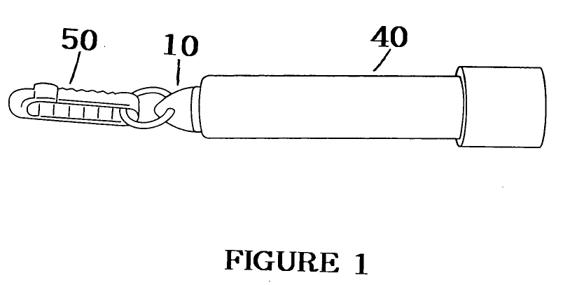

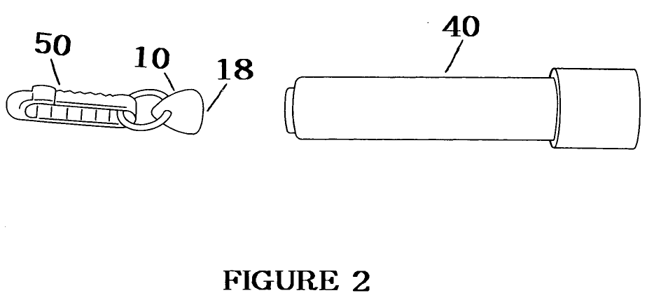

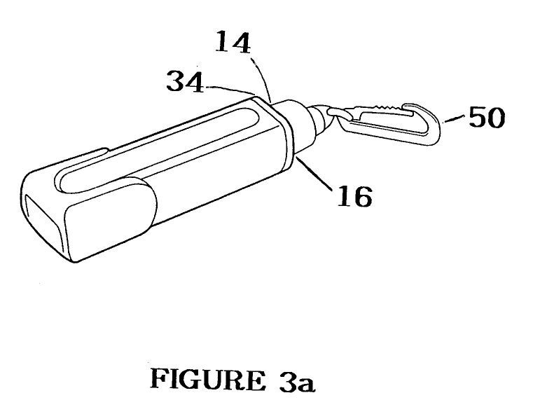

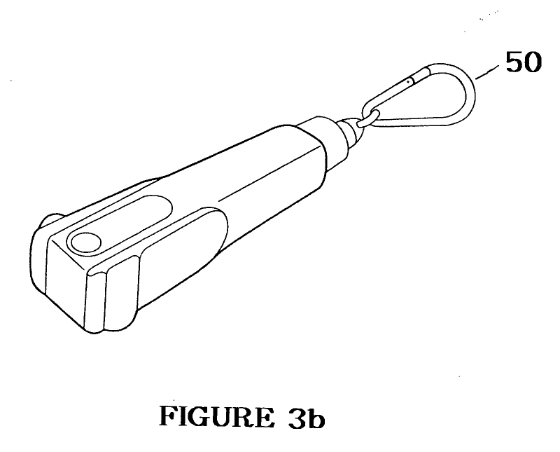

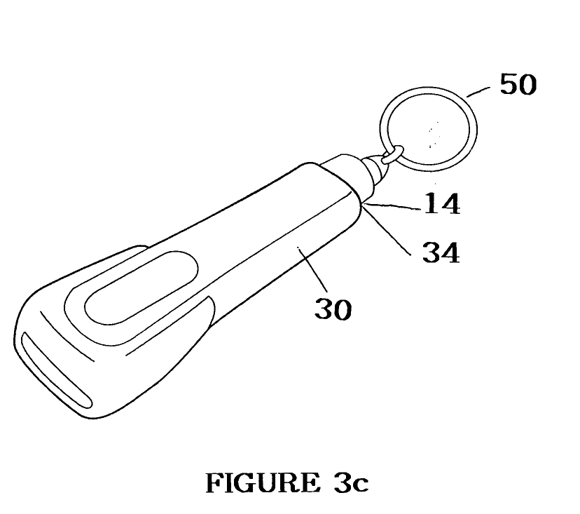

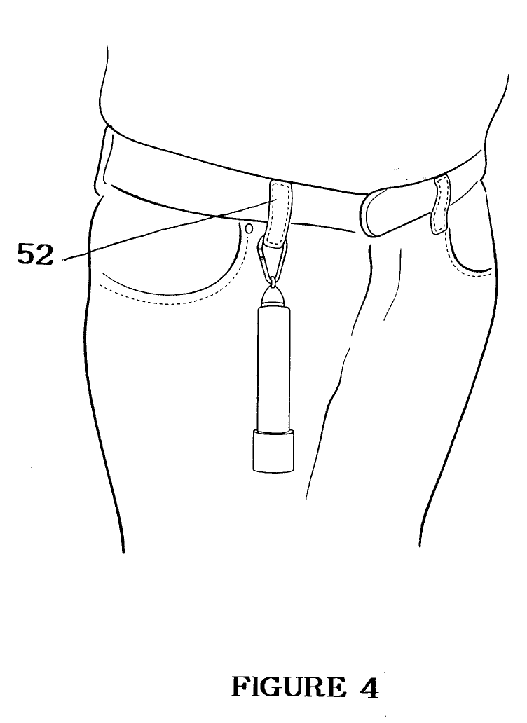

The use of magnetic belt clip allows the user to quickly and without difficulty tether a wireless device such as a data collection device; see FIG. 1 through FIG. 4. The wireless device can be data collection device can be a scanner such as a CCD or laser scanner, a blue tooth scanner or other known data collections device. It could also be a device that output data such as a printer.

The magnetic connector also allows for effortless grabbing of the tethered device without the hassle of a cord. By eliminating the cord or holster the inventive tether allows the user to grab the scanner easily without having to overcome the pull of a cord or the difficulty of removing a device from a holster. This allows the user quicker access to the device and also allows simple securing of the device to the body of the operator once a data collection operation is finished.

The magnetic snap cap 10 connector comprises a connector tip 12 for inserting into the end of a receptacle 30. A magnet 14 is at least partially embedded in the front face 16 of the cap 10. The magnet 14 of the cap 10 projects far enough from the face 16 so that, when the cap 10 is attached to a receptacle 30, the magnet 14 is in contact with magnetic surface 34 of the receptacle 30. The receptacle 30 holds the wireless device 40. The wireless device 40 may be a data collection device such as a scanner.

In another embodiment, the cap comprises a tube 18. Magnet 14 is positioned within the tube 18, preferably the magnet 14 partially projecting from the front end of the tube 18. The magnetic connector of the receptacle is inserted in the tube to secure connection.

The cap preferably has a connector 50 to allow the holder to be attached to a belt loop 52 or other object. The connector can be any know clip. The connector can be, for example, a clasp, a clip, a hook, a spring clip, a spring clasp, a jaw clip, a spring ring clasp, a parrot clasp, a trigger clasp, a swivel clasp, a swivel hook, an eye hook, a trigger snap clip, a pelican hook, a jaw hook, a loose leaf ring, or a carabineer.

1. A retaining device for securing a wireless device to a user comprising:
the wireless device,
a first magnet attached to one end of the wireless device,
a detachable cap having a second magnet and a connector for attaching the wireless device to a user.

2. The retaining device of claim 1 wherein the second magnet is at least partially embedded in a front face of the cap.

3. The retaining device of claim 1 wherein the cap comprises a tube opposite from the connector and the second magnet is at least partially embedded in the tube.

4. The retaining device of claim 1 further comprising a receptacle for the data entry device.

5. The retaining device of claim 4 wherein the first magnet is attached on the outside of the receptacle.

6. The retaining device of claim 4 wherein the receptacle comprises a tube on one end and the first magnet is positioned in the tube.

7. The retaining device of claim 6 wherein the first magnet protrudes from the tube.

8. The retaining device of claim 4 wherein the cap compromises a tube opposite from the connector, the second magnet is within the tube and the first magnet is adapted to be partially inserted into the tube.

9. The retaining device of claim 6 wherein the second magnet is adapted to be partially inserted in the tube.

10. The retaining device of claim 1 wherein the connector is selected from the group comprising clips, clasps, hooks, spring clips, spring clasps, jaw clips, spring ring clasps, parrot clasps, trigger clasps, swivel clasps, swivel hooks, eye hooks, trigger snap clips, pelican hooks, jaw hooks, loose leaf rings, and carabineers.

11. The retaining device of claim 1 wherein the cap further comprises a swivel.

12. The retaining device of claim 2 wherein the second magnet is adapted to be partially inserted in the tube.

13. The retaining device of claim 3 wherein the first magnet is adapted to be partially inserted into the tube.

14. The retaining device of claim 5 wherein the cap compromises a tube opposite from the connector, the second magnet is within the tube and the first magnet is adapted to be partially inserted into the tube.

15. The retaining device of claim 1 wherein wireless device is a date entry device.

16. The retaining device of claim 15 wherein the data entry device is a scanner.
